(19) United States
(12) Patent Application Publication
(10) Pub. No.: US 2007/0217889 A1
(43) Pub. Date: Sep. 20, 2007

(54) Pin fastener having a sharp point

(76) Inventors: Kevin Greene, Fairland, IN (US); Don Kudlak, Hoschton, GA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/402,460

(22) Filed: Apr. 12, 2006

Related U.S. Application Data
(60) Provisional application No. 60/782,011, filed on Mar. 14, 2006.

(51) Int. Cl. F16B 15/00

(52) U.S. Cl. 411/493

(57) ABSTRACT

A pin fastener includes a head, a shank, and a tip. The shank includes a knurled section and an unknurled section, and the knurled section includes a tapered section that is tapered to provide a lead in from the unknurled section. In addition, the tip is a conical shape.

### CROSS-REFERENCE TO RELATED APPLICATIONS

This application claims the benefit of U.S. Provisional Patent Application Ser. No. 60/782,011, filed Mar. 14, 2006.

### FIELD OF THE INVENTION

One embodiment of the present invention is directed to a fastener. More particularly, one embodiment of the present invention is directed to a pin type fastener having a sharp point.

### BACKGROUND INFORMATION

Fasteners of various configurations are known for fastening relatively thick work pieces, such as plywood, to various substrates, such as metal framing members. Such fasteners typically have elongated shanks defining axes and include smooth and flat heads to be axially driven by power tools, such as pneumatically-powered or combustion-powered tools. Many known pin fasteners utilize a ballistic point to penetrate materials.

Attributes of such a fastener that determines its effectiveness include its withdrawal value and shear strength. As such, there is a need for an improved fastener that has an increased withdrawal value and greater shear strength than known fasteners.

### SUMMARY OF THE INVENTION

One embodiment of the present invention is a pin fastener that includes a head, a shank, and a tip. The shank includes a knurled section and an unknurled section, and the knurled section includes a tapered section that is tapered to provide a lead in from the unknurled section. In addition, the tip is a conical shape. Other aspects of the invention will become clear from review of the remainder of this disclosure.

### BRIEF DESCRIPTION OF THE DRAWINGS

FIG. 1 is a side view of a pin fastener in accordance with one embodiment of the present invention.

FIG. 2 is an expanded side view of the lower portion of a pin fastener in accordance with one embodiment of the present invention.

### DETAILED DESCRIPTION

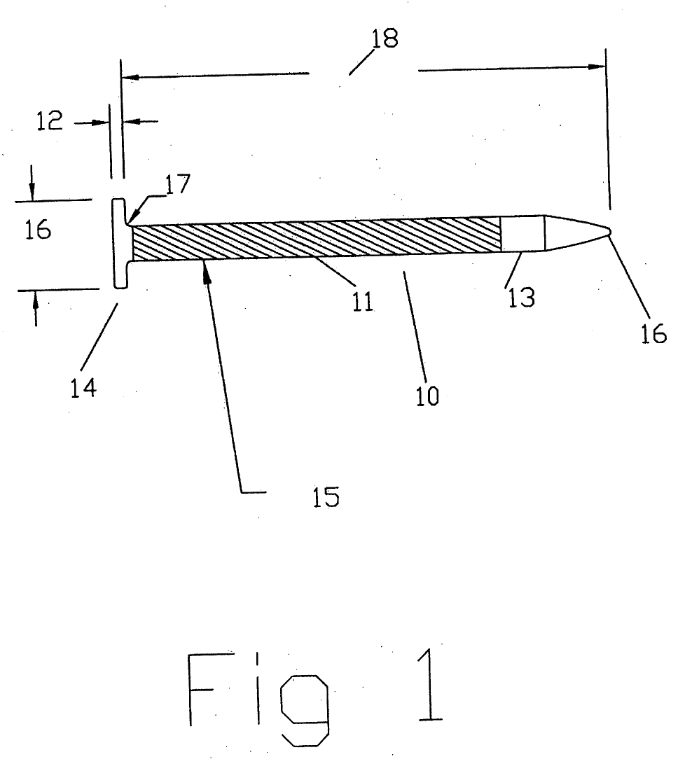

FIG. 1 is a side view of a pin fastener in accordance with one embodiment of the present invention. Pin 10 includes a head 14, a shank 15 and a tip 16. Shank 15 includes a knurled section 11 and an unknurled section 13.

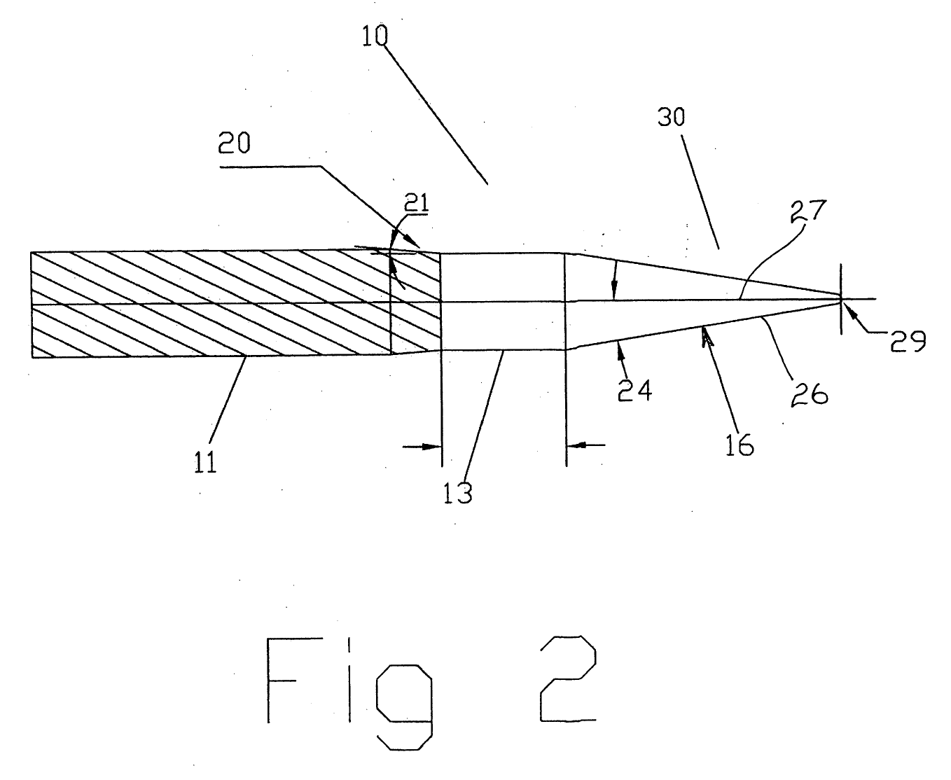

FIG. 2 is an expanded side view of the lower portion of pin 10 in accordance with one embodiment of the present invention. The lead in portion of knurled section 11 includes a tapered section 20 which has an angle 21 of 5° to form a tapered lead in from unknurled section 13. The 5° lead in assists in penetrating steel and other materials while minimizing the deflection of the materials. In other embodiments, angle 21 can be in the range of approximately 3° to approximately 7°.

The tip 16 is in the shape of a cone and has a conical surface, represented by the element 26 of FIG. 2, that defines an angle 24 with the axis 27 of 9°. This conical shape, with angle 24 as defined, results in a sharp point relative to the prior art. In other embodiments, the angle 24 can be in the range of approximately 7° to approximately 11°.

In one embodiment, pin 10 is formed from 1060 steel and has two types of hardness applied. The core is subjected to a Heat treat Rc 52-54, and the surface is subjected to an Austemper R45n39-48. Pin 10 is further plated with electroplated zinc with a clear dichromate rinse to a minimum 0.0005″ thickness, and is baked for six hours after plating. In other embodiments, any other type of galvanizing plating method can be used.

In one embodiment, head 14 has a diameter 16 of 0.25″, a thickness 12 of 0.035″ and a radius 17 at its intersection with shank 15 of 0.015″. Further, the distance 18 between the bottom of shank 15 and the end of tip 16 is 1.38″.

In one embodiment, knurled section 11 has the following specifications: (1) 32 threads per inch (“TPI”) 90° diagonal; (2) 26° vertical plane right hand; (3) major diameter 0.103″-0.107″; and (4) Thread die #01136 (“Gripshank®”).

In one embodiment, the point of tip 16 has a radius 29 of 0.01″ and the length 30 of tip 16 is 0.27″.

As described, the pin in accordance with embodiments of the present invention provides unique benefits, especially for the fastening of various material to thin, high-tensile grades of steel and fastening steel-to-steel connections. The benefits include higher withdrawal values and greater shear strengths when used in steels that are 20 gauge and lighter, and with tensiles that are greater than 50 ksi.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A pin fastener comprising:
a head;
a shank coupled to said head, said shank comprising a knurled section and an unknurled section; and
a tip coupled to said shank;
wherein said knurled section comprises a tapered section that is tapered to provide a lead in from said unknurled section.

2. The pin fastener of claim 1, wherein said tapered section has an angle of approximately 3-7 degrees.

3. The pin fastener of claim 1, wherein said tapered section has an angle of approximately 5 degrees.

4. The pin fastener of claim 1, wherein said tip is a conical shape.

5. The pin fastener of claim 4, wherein said tip has a conical surface that defines an angle of approximately 7-11 degrees with the axis of the cone.

6. The pin fastener of claim 4, wherein said tip has a conical surface that defines an angle of approximately 9 degrees with the axis of the cone.

7. The pin fastener of claim 1, wherein said knurled section comprises a Gripshank® thread design.

8. A pin fastener comprising:
a head;
a shank coupled to said head, said shank comprising a knurled section and an unknurled section; and
a tip coupled to said shank;
wherein said tip is a conical shape.

9. The pin fastener of claim 8, wherein said tip has a conical surface that defines an angle of approximately 7-11 degrees with the axis of the cone.

10. The pin fastener of claim 8, wherein said tip has a conical surface that defines an angle of approximately 9 degrees with the axis of the cone.

11. The pin fastener of claim 8, wherein said knurled section comprises a tapered section that is tapered to provide a lead in from said unknurled section.

12. The pin fastener of claim 11, wherein said tapered section has an angle of approximately 3-7 degrees.

13. The pin fastener of claim 11, wherein said tapered section has an angle of approximately 5 degrees.

14. The pin fastener of claim 8, wherein said knurled section comprises a Gripshank® thread design.
